(19) United States
(12) Patent Application Publication
(10) Pub. No.: US 2026/0237937 A1
(43) Pub. Date: Aug. 13, 2026

(54) ON-WIRE STRAIN RELIEF CABLE

(71) Applicant: Molex, LLC, Lisle, IL (US)

(72) Inventors: Seán Francis McGreevy, Galway (IE); Harold Keith Lang, Lisle, IL (US)

(21) Appl. No.: 19/152,448

(22) PCT Filed: Jan. 25, 2024
(86) PCT No.: PCT/IB2024/050686

§ 371 Date: Jul. 31, 2025

Related U.S. Application Data
(60) Provisional application No. 63/445,004, filed on Feb. 13, 2023.

(51) Int. Cl. H01R 13/58

(52) U.S. Cl. CPC H01R 13/5812

(57) ABSTRACT

Various aspects of on-wire strain relief in cable assemblies are described herein. In one example, a cable assembly includes a cable and a modular plug at one end of the cable. The cable includes an outer jacket and wires extending within the outer jacket. The modular plug includes a modular housing and an interlock for on-wire strain relief between the wires and the modular plug. Because the wires within the cable are mechanically secured using the on-wire strain relief interlock features within the modular plug, the cable assembly can withstand significant, and opposite, pulling forces between the cable and the modular plug, without separation, damage, or loss in signal coupling integrity.

### CROSS-REFERENCE TO RELATED APPLICATION

This application claims the benefit of U.S. Provisional Application No. 63/445004, filed Feb. 13, 2023, and entitled “ON-WIRE STRAIN RELIEF CABLE,” which is incorporated by reference herein in its entirety.

### BACKGROUND

Cables and cable assemblies can be relied upon for data communications in a wide range of computing and data interconnect systems. A typical cable assembly includes signal wires or conductors, a cable jacket surrounding the wires, and modular plugs or connectors coupled at the ends of the wires. The cables can be cut to a specific length, and the modular connectors can be crimped or otherwise secured to the ends of the cables. Cable assemblies can provide data and power interconnects among computers, servers, network switches, sensors, motors, and other devices.

### SUMMARY

Examples of on-wire strain relief for cable assemblies are described. An example cable assembly includes a cable and a modular plug at one end of the cable. The cable includes an outer jacket and wires extending within the outer jacket. The modular plug includes a modular housing and an interlock for on-wire strain relief between the wires and the modular plug. Because the wires within the cable are mechanically secured using the on-wire strain relief interlock within the modular plug, the cable assembly can withstand significant, and opposite, pulling forces between the cable and the modular plug, without separation, damage, or loss in signal coupling integrity. The cable assembly can also include a molding formed between the cable and the modular plug. In contrast to other cables, the outer jacket is cut away and ends within the molding. The outer jacket does not extend to and is not secured within the modular plug.

In other aspects of the embodiments, the modular plug includes a wire insert. The wire insert includes a wire insert channel, and the wire insert channel includes a planar extension region and an incline extension region. The planar extension region extends parallel to a bottom surface of the wire insert, and the incline extension region extends at an angle with respect to the bottom surface of the wire insert. The angle can vary among the examples. The angle can vary between 5 and 20 degrees, for example, although larger or smaller angles can be relied upon in some cases.

In other aspects, the wire insert includes a strain relief groove that extends, from a top surface of the wire insert, into the wire insert. The strain relief groove intersects with and opens the wire insert channel in the incline extension region. The interlock of the modular plug extends into the strain relief groove of the wire insert, locking the wire insert within the modular plug by a mechanical interference between the wire insert and the interlock.

In other aspects, a wire of the cable extends through the wire insert channel of the wire insert. A region of the wire is exposed over the strain relief groove of the wire insert. The interlock of the modular plug extends into the strain relief groove of the wire insert, securing the wire within the modular plug by a mechanical interference between the wire and the interlock. In other aspects of the embodiments, the cable includes a drain wire extending within the outer jacket, the modular plug further comprises a shield, and the drain wire is crimped and electrically coupled to a crimping loop of the shield.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of an example cable assembly according to various embodiments of the present disclosure.

FIG. 2A illustrates a front perspective view of the cable assembly shown in FIG. 1, with the module molding omitted from view, according to various embodiments of the present disclosure.

FIG. 2B illustrates a rear perspective view of the cable assembly shown in FIG. 1, with the module molding omitted from view, according to various embodiments of the present disclosure.

FIG. 3 illustrates the modular plug of the cable assembly shown in FIG. 1, before assembly and crimping, according to various embodiments of the present disclosure.

FIG. 4 illustrates the modular plug, wire insert, and cable of the cable assembly shown in FIG. 1, before assembly and crimping, according to various embodiments of the present disclosure.

FIG. 5 illustrates a perspective view of the wire insert of the cable assembly shown in FIG. 1 according to various embodiments of the present disclosure.

FIG. 6A illustrates a front view of the wire insert of the cable assembly shown in FIG. 1 according to various embodiments of the present disclosure.

FIG. 6B illustrates a back view of the wire insert of the cable assembly shown in FIG. 1 according to various embodiments of the present disclosure.

FIG. 6C illustrates a bottom view of the wire insert of the cable assembly shown in FIG. 1 according to various embodiments of the present disclosure.

FIG. 6D illustrates a top view of the wire insert of the cable assembly shown in FIG. 1 according to various embodiments of the present disclosure.

FIG. 7A illustrates a perspective cross-sectional view of the wire insert designated A-A in FIG. 6D according to various embodiments of the present disclosure.

FIG. 7B illustrates the cross-sectional view of the wire insert designated A-A in FIG. 6D according to various embodiments of the present disclosure.

FIG. 8 illustrates a cross-sectional view of the cable assembly shown in FIG. 1 according to various embodiments of the present disclosure.

### DETAILED DESCRIPTION

Cables and cable assemblies can be relied upon for data communications in a wide range of computing and data interconnect systems, among other applications. A typical cable assembly can include signal wires or conductors, a cable jacket surrounding the wires, and modular plugs or connectors coupled at the ends of the wires. The cables can be cut to a specific length, and the modular connectors can be crimped or otherwise secured to the ends of the cables. Cable assemblies can provide data and power interconnects among computers, servers, network switches, sensors, motors, and other devices.

In some cable assemblies, the outer jacket of the cable is crimped or otherwise mechanically secured within the modular plug of the cable assembly using a crimping tool. An interlock feature of a modular plug, for example, can be crimpled or otherwise pressed and secured against the outer jacket of the cable in some cases, to mechanically secure the outer jacket with the modular plug. The outer jacket can thus be secured to prevent the cable from being pulled out and apart from it, which could disturb the electrical couplings or terminations between the signal wires of the cable and contact blades of the modular plug. However, the outer jackets of some cables may be too large in diameter to fit within industry-standard sizes of modular plugs, particularly when the cables include wires of relatively large gauge.

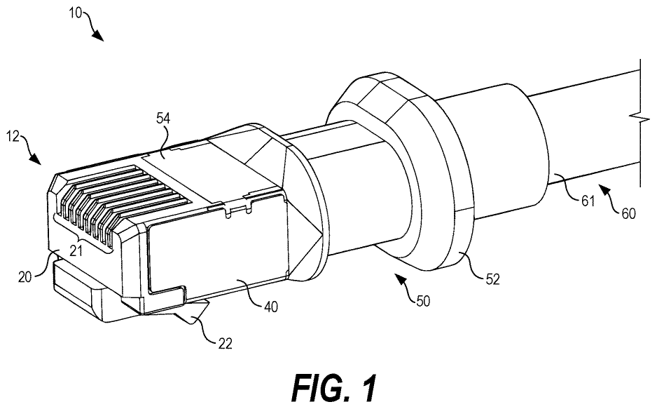

In the context outlined above, various aspects of on-wire strain relief in cable assemblies are described herein. An example cable assembly includes a cable and a modular plug at one end of the cable. The cable includes an outer jacket and wires extending within the outer jacket. The modular plug includes a modular housing and an interlock for on-wire strain relief between the wires and the modular plug. Because the wires within the cable are mechanically secured using the on-wire strain relief interlock within the modular plug, the cable assembly can withstand significant, and opposite, pulling forces between the cable and the modular plug, without separation, damage, or loss in signal coupling integrity. Turning to the drawings, FIG. 1 illustrates a perspective view of an example cable assembly 10 according to various embodiments of the present disclosure. The cable assembly 10 is representative in FIG. 1, not drawn to any particular scale, and is illustrated to provide context for the concepts of the on-wire strain relief cables described herein. The cable assembly 10 can be designed for data communications and includes a number of twisted pairs of signal wires or conductors. The cable assembly 10 can be a Category 5, 6, 7, 8, or related cable, although the concepts described herein are not limited to use with any particular type or style of cable. The cable assembly 10 can be shielded or unshielded in various examples, using a foil shielding, braided shielding, drain wire, or other shield, and include four pairs of twisted signal wires or conductors in one example. Overall, the concepts of on-wire strain relief are not limited to use with any particular type or style of cable or cable assembly, as the concepts can be extended to use with related cables and cable assemblies beyond the examples described herein.

As shown in FIG. 1, the cable assembly 10 includes modular plug 12, a cable 60 having wires that are terminated at the modular plug 12, and a module molding 50. The modular plug 12 includes a modular plug housing 20, a number of contact channels 21 formed in the top and front of the modular plug housing 20, a plug interlock arm 22, and a shield 40 that extends around a number of sides of the modular plug housing 20, among other features. The cable 60 includes a number of wires or conductors extending within the outer jacket 61. The signal wires of the cable 60 are electrically coupled and terminated to contact blades that are inserted and positioned within the contact channels 21, as would be understood in the field and described in further detail below. A drain wire of the cable 60 is electrically coupled and terminated to the shield 40 of the cable assembly 10, as also described below. The shield 40 helps to reject external electromagnetic interference from the modular plug 12.

The cable assembly 10 can be embodied as a cable for data communication applications, similar to a Category 5, 6, 7, 8, or related cable. In that context, the modular plug 12 can be designed as an RJ45 modular plug, in one example. The modular plug 12 can be inserted into a modular port, such as an RJ45 port, for making an electrical connection between the signal wires of the cable 60 and pins or terminals within the port, as would be understood in the field. The cable assembly 10 can be formed from a range of suitable materials. For example, the modular plug housing 20 can be formed from a plastic or other polymer material and the shield 40 can be formed (e.g., sheared, bent, or otherwise formed) from a conductive metal sheet. The cable 60 can include a number a wires or conductors, such as sheathed copper wires of 22, 24, 26, or 28 American wire gauge (AWG), for example, a foil or braided shield or an unshielded drain wire of 22, 24, 26, or 28 AWG, and an outer jacket formed of polyvinyl chloride or another suitable material. The module molding 50 can be molded around the modular plug 12 and the end of the cable 60, using polyvinyl chloride or another polymer-based material suitable for molding. The module molding 50 includes a circumferential grip ring 52, which can be helpful to grab and position the cable assembly 10, as the modular plug 12 is inserted into or retracted out from a modular port.

In cable assemblies similar to the cable assembly 10, the outer jacket 61 of the cable 60 is typically crimped or otherwise mechanically secured within the modular plug housing 20 using a crimping tool. For example, one or more strain relief interlock features of the modular plug housing 20 can be crimpled or otherwise pressed and secured against the outer jacket 61, within the modular plug housing 20, to mechanically secure the outer jacket 61 with the modular plug housing 20. The outer jacket 61 is thus secured within the modular plug housing 20 to prevent the cable 60 from being pulled out and apart from the modular plug housing 20, which could disturb the electrical couplings or terminations between the signal wires of the cable 60 and the contact blades that are positioned within the contact channels 21.

However, the outer jacket 61 of the cable 60 may be too large in diameter or other characteristics in some cases to fit within the modular plug housing 20, particularly when the cable 60 includes signal wires of relatively large gauge. Additionally, the module molding 50 is not necessarily designed to securely hold the outer jacket 61 of the cable 60 or to secure it to the modular plug housing 20. Without a way to secure the outer jacket 61 of the cable 60 to the modular plug housing 20, the cable 60 may be susceptible to being pulled apart from the modular plug 12, damaging the cable assembly 10.

According to aspects of the embodiments described herein, the cable assembly 10 is design to facilitate direct strain relief between the wires within the cable 60 and the modular plug 12, rather than between the outer jacket 61 and the modular plug 12. As described below, the outer jacket 61 of the cable 60 is cut back and does not extend into the modular plug housing 20 of the modular plug 12. Instead, the outer jacket 61 only extends to a point within the module molding 50. However, because the wires or conductors within the cable 60 are mechanically secured using an on-wire strain relief design within the modular plug housing 20, the cable assembly 10 can withstand significant, and opposite, pulling forces between the cable 60 and the modular plug housing 20, without separation, damage, or loss in signal coupling integrity.

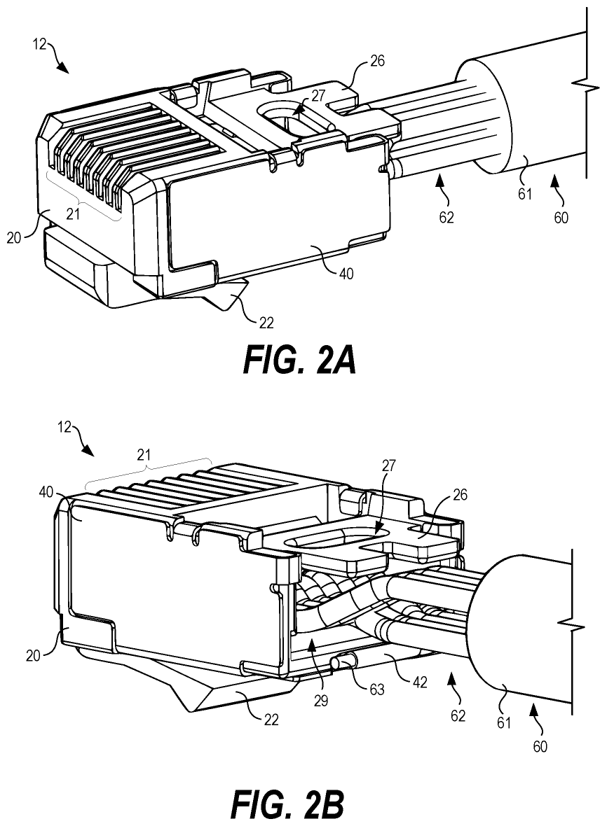

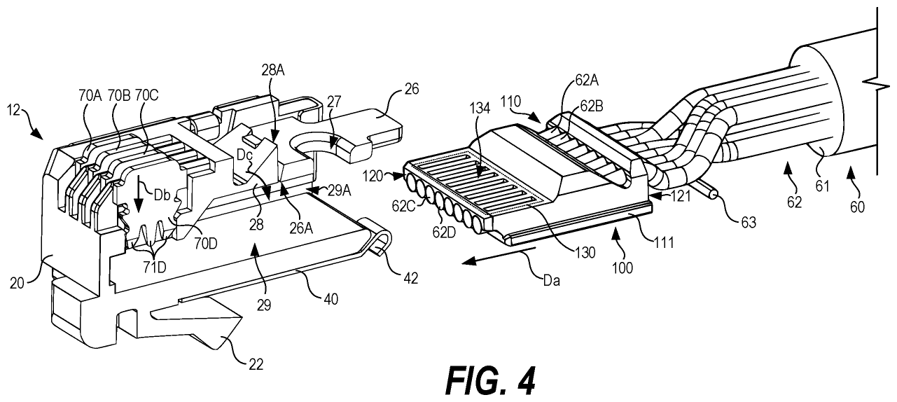

FIG. 2A illustrates a front perspective view of the cable assembly 10 shown in FIG. 1, with the module molding 50 omitted from view. FIG. 2B illustrates a rear perspective view of the cable assembly 10 with the module molding 50 omitted from view. Additional features of the modular plug 12 and the cable assembly are visible in FIGS. 2A and 2B. The modular plug 12 includes a plug cavity 29 within the modular plug housing 20. The wires 62 of the cable 60 extend into the plug cavity 29, where they are arranged, inline, for coupling to contact blades within the contact channels 21 of the modular plug 12. The wires 62 of the cable 60 are arranged in a linear, side-by-side fashion, using a wire insert, within the plug cavity 29. The wire insert is described in further detail below with reference to FIGS. 4, 5, and 6A-6D.

The outer jacket 61 does not extend to a point within the modular plug 12. Instead, the outer jacket 61 is cut back before entering the modular plug 12. The wires 62 of the cable 60, however, do extend into the plug cavity 29 of the modular plug 12 and are terminated at the modular plug 12. The wires 62 include twisted pairs of signal wires or conductors, such as four twisted pairs in the example shown, along with a drain wire 63. The signal conductors of the wires 62 are terminated and electrically coupled to contact blades positioned within the contact channels 21 of the modular plug 12. The drain wire 63 is crimped to the crimping loop 42 of the shield 40 at the back of the modular plug 12.

The modular plug housing 20 also includes a molding relief tab 26, which includes a molding aperture 27. After the cable 60 is assembled with the modular plug 12, as shown in FIGS. 2A and 2B, the module molding 50 can be molded around the modular plug 12 and the cable 60 in a separate assembly step. The material of the module molding 50 can extend or flow through the molding aperture 27, into the back of the modular plug 12, and over the top of the modular plug 12, to form the top 54 (see FIG. 1) of the module molding 50.

As described above, the cable assembly 10 is designed to facilitate direct strain relief between the wires 62 of the cable 60 and the modular plug housing 20, rather than between the outer jacket 61 and the modular plug housing 20. The outer jacket 61 of the cable 60 is cut back and does not extend into the modular plug housing 20. Because the wires 62 of the cable 60 are mechanically secured using an on-wire strain relief design within the plug cavity 29 the modular plug housing 20, the cable assembly 10 can withstand significant, and opposite, pulling forces between the cable 60 and the modular plug 12, without separation, damage, or loss in signal coupling integrity.

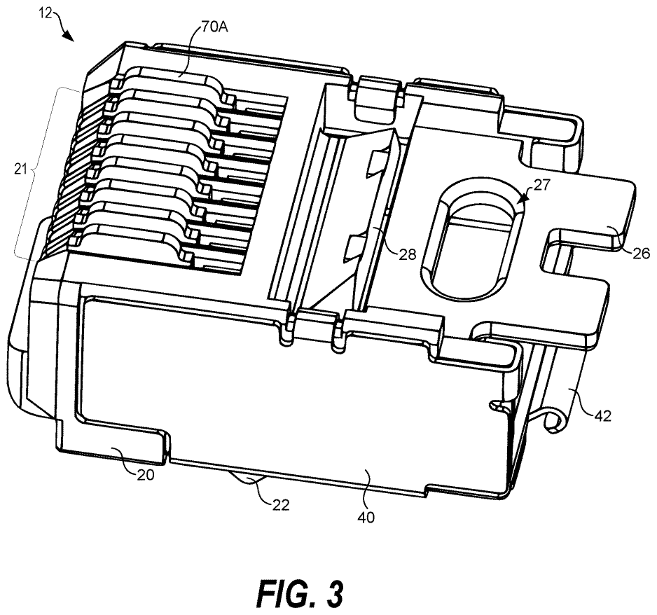

FIG. 3 illustrates the modular plug 12 of the cable assembly 10 shown in FIG. 1, before assembly and crimping, according to various embodiments of the present disclosure. The modular plug 12 includes a number of contact blades, such as the contact blade 70A, among others, positioned within the contact channels 21. The contact blades are pressed down and into the wires 62 of the cable 60, respectively, when the modular plug 12 is crimped to the cable 60 using a crimping tool. The contact blades electrically couple to and contact the wires 62 when the modular plug 12 is crimped to the cable 60.

The modular plug housing 20 also includes an on-wire relief interlock 28 (“interlock 28”). The interlock 28 is shown in a raised position in FIG. 3. The interlock 28 can be rotated and pressed down into the plug cavity 29 of the modular plug housing 20, to mechanically compress against and secure the wires 62 of the cable 60 within the modular plug 12, when the modular plug 12 is crimped to the cable 60.

FIG. 4 illustrates the modular plug 12, wire insert 100, and cable 60 of the cable assembly 10 shown in FIG. 1, before assembly and crimping, according to various embodiments of the present disclosure. A cross-sectional view of the modular plug 12 is shown in FIG. 4, so that the plug cavity 29 within the modular plug 12 is visible. The wires 62 of the cable 60 are arranged in a linear, side-by-side fashion, in the wire insert 100, before the wire insert 100 is inserted within the plug cavity 29 of the modular plug 12. More particularly, the wires 62A-62D, among others, are shown as being inserted and extended through wire insert channels within the wire insert 100. The wires 62A-62D extend from the back end 121 of the wire insert 100 to the front end 120 of the wire insert 100.

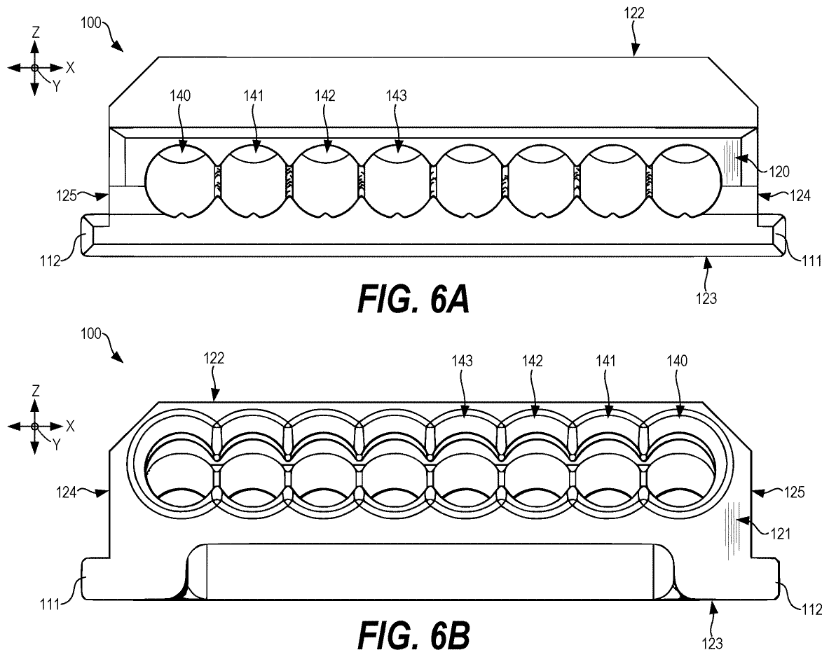

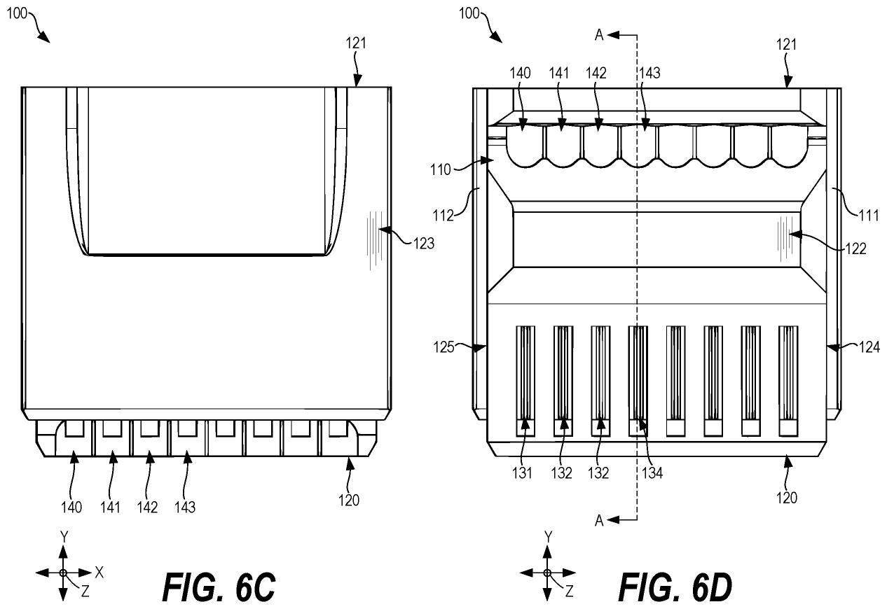

After being arranged as shown, the wire insert 100 and wires 62 can be inserted, together, into the plug cavity 29 of the modular plug 12 in the direction “Da” shown in FIG. 4. Additionally, the drain wire 63 can be positioned and fitted into the crimping loop 42 of the shield 40 at the back of the modular plug 12. To facilitate alignment, the wire insert 100 includes an insert interlock rail 111 on one side and an insert interlock rail 112 (see FIGS. 6A and 6B) on another, opposite side of the wire insert 100. The interlock rails 111 and 112 extend from the back end 121 to the front end 120 of the wire insert 100, along the bottom of the wire insert 100. The interlock rail 112 can extend and slide into the interlock channel 29A of the modular plug housing 20, when the wire insert 100 is inserted into the modular plug 12, to help position and align the wire insert 100 within the plug cavity 29. The interlock rail 111 can also extend and slide into a similar interlock channel (not shown) at an opposite side of the modular plug housing 20.

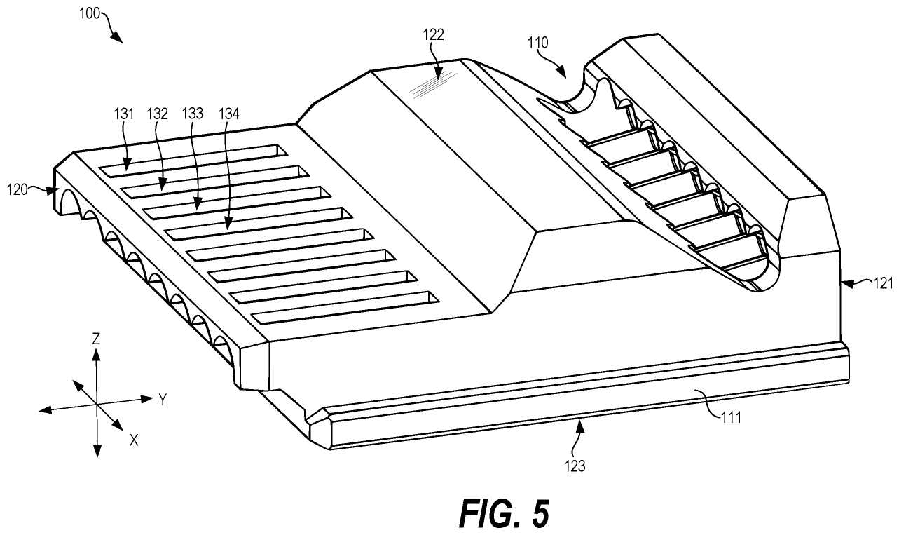

The wire insert 100 includes a blade aperture region 130, which includes a number of contact blade apertures 130-134 (see also FIG. 5), among others. The contact blade apertures 130-134 are apertures or openings through the wire insert 100. The blade aperture region 130 can be positioned under the contact blades 70A-70D of the modular plug 12, when the wire insert 100 and wires 62 are fully inserted into the plug cavity 29 of the modular plug 12. After insertion, the modular plug 12 can be crimped to the wire insert 100 and the wires 62 of the cable 60.

In the crimping step, the contact blades 70A-70D of the modular plug 12 are pressed down in the direction “Db” shown in FIG. 4. The contact blades 70A-70D are pressed down and extend, in part, through the contact blade apertures 130-134 of the wire insert 100 in this step, to make electrical coupling with the wires 62A-62D, among others, of the cable 60. For example, the tapered contact points 71D of the contact blade 70D will extend down through the contact blade aperture 134 of the wire insert 100 and extend, in part, into the wire 62D. The contact blade 70D will make an electrical coupling to the wire 62D in this crimping step. The other contact blades will also be electrically coupled to the other wires 62 of the cable 60 in a similar way.

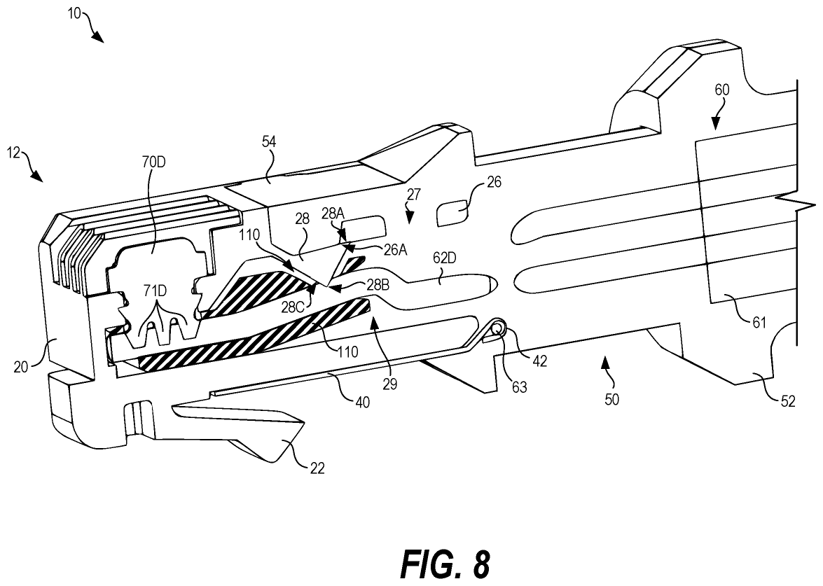

The interlock 28 of the modular plug housing 20 is also pressed down and rotated in the direction “Dc,” as shown in FIG. 4, during crimping. The wire insert 100 includes a strain relief groove 110. A portion of the wires 62A-62D, or the insulative sleeves of the wires 62A-62D, are exposed over the strain relief groove 110. The interlock 28 is pressed and rotated down in the direction “Dc,” into the area of the strain relief groove 110, during crimping. More particularly, the interlock 28 is rotated down until the interlock edge 28A is snapped and seated below the locking edge 26A of the molding relief tab 26, as also shown in FIG. 8. The interlock 28 is then held and locked in place based on a mechanical interference between the interlock edge 28A and the locking edge 26A.

The interlock 28 is also compressed against the wires 62A-62D, which are exposed over the strain relief groove 110 of the wire insert 100, in this locked position. The interlock 28 thus provides a direct, on-wire strain relief, as it is pressed against the wires 62 of the cable 60 in this arrangement. Rather than the interlock 28 compressing against the outer jacket 61 of the cable 60, for example, the interlock 28 directly contacts the wires 62 or sleeves of the wires 62, holding the wires 62 and the wire insert 100 in place.

FIG. 5 illustrates a perspective view of the wire insert 100 of the cable assembly 10 shown in FIG. 1 according to various embodiments of the present disclosure. Additionally, FIG. 6A illustrates a front view, FIG. 6B illustrates a back view, FIG. 6C illustrates a bottom view, and FIG. 6D illustrates a top view of the wire insert 100. The wire insert 100 is illustrated as a representative example in FIGS. 5 and 6A-6D. The wire insert 100 is not drawn to any particular scale or size, and it can vary in size, shape, and style in some cases. The wire insert 100 can be formed from a plastic, polymer, or other suitable materials.

Referring among 6A-6D, the wire insert 100 includes a front end 120, a back end 121, a top surface 122, and a bottom surface 123. As best shown in FIGS. 6A and 6B, the wire insert 100 also includes a number of wire insert channels, including the wire insert channels 140-143, among others, that extend from the front end 120 to the back end 121 of the wire insert 100. Eight (8) wire insert channels are shown, but the wire insert 100 can include additional or fewer insert channels in other examples. The wire insert channels intersect with each other, in part, forming a single, continuous insert channel within the wire insert 100. The insert channel is formed to include a number of cylindrical clearances or openings, each sized to provide a nominal clearance for extension of a signal wire of the cable 60. For example, each of the wire insert channels 140-143 provides a cylindrical clearance or opening for extension of one of the wires 62A-62D of the cable 60, among others.

As shown in FIG. 4, the wires 62A-62D of the cable 60 can be inserted, respectively, into the wire insert channels 140-143. The wire insert 100 includes a strain relief groove 110. The strain relief groove 110 is formed as a type of material void or cutout, extending into the wire insert 100 from the top surface 122. The strain relief groove 110 intersects with (and exposes or opens) the wire insert channels in the wire insert 100, at a position along an inclined channel region of the wire insert channels. Thus, a portion of the wires 62A-62D, or the insulative sleeves of the wires 62A-62D, are exposed over the strain relief groove 110, as also shown in FIG. 4.

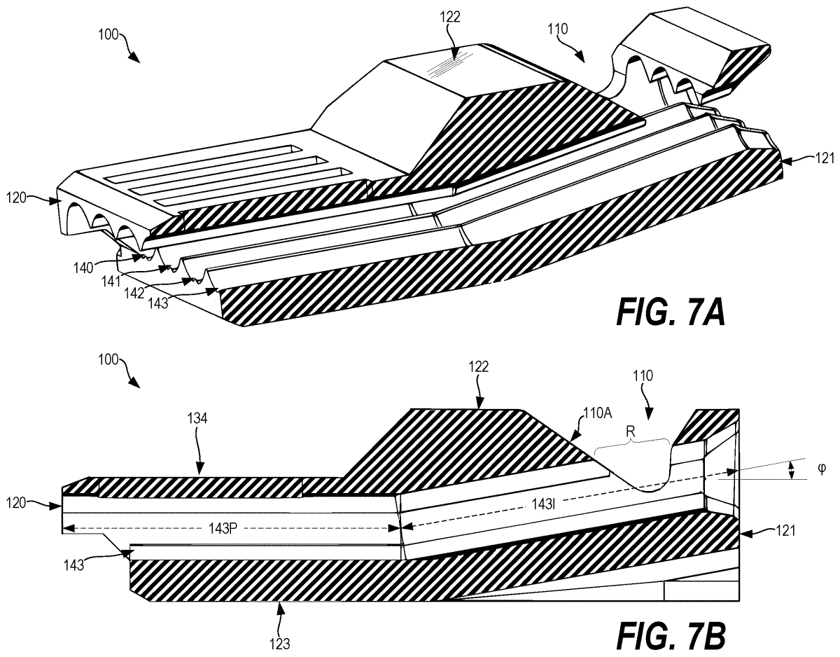

FIG. 7A illustrates a perspective cross-sectional view of the wire insert 100 designated A-A in FIG. 6D, and FIG. 7B illustrates the cross-sectional view designated A-A in FIG. 6D. As shown in FIG. 7A, the strain relief groove 110 is formed as a type of void or cutout, extending into the wire insert 100 from the top surface 122. The strain relief groove 110 intersects with (and exposes or opens) the wire insert channels in the wire insert 100. As one particular example, FIG. 7B illustrates a region “R” over which the wire insert channel 143 is opened and exposed in the strain relief groove 110.

Referring to FIG. 7B, the wire insert channel 143 includes a planar extension region 143P and an incline extension region 143I. The planar extension region 143P extends parallel to the bottom surface 123 of the wire insert 100 and under the contact blade aperture 134. The incline extension region 143I extends at an angle “q” with respect to the bottom surface 123 of the wire insert 100 and intersects with the strain relief groove 110. The angle “p” can vary among the embodiments. The angle “q” can vary between 5 and 20 degrees, for example, although larger or smaller angles can be relied upon in some cases. As particular examples, the angle “q” can be about 5, 6, 7, 8, 9, 10, 11, 12, 13, 14, or 15 degrees. In the example shown, the angle “p” is about 10 degrees, although other angles can be relied upon.

FIG. 8 illustrates a cross-sectional view of the cable assembly 10 shown in FIG. 1 according to various embodiments of the present disclosure. The sectional view shown in FIG. 8 is taken along the same plane as that designated A-A in FIG. 6D. The wire insert 100 and wires 62 of the cable 60 are positioned within the plug cavity 29 of the modular plug 12, which is also filled with the material of the module molding 50. The module molding 50 also extends through the molding aperture 27 of the molding relief tab 26 (see also FIG. 4). The drain wire 63 is positioned and crimped into the crimping loop 42 of the shield 40, to provide an electrical coupling between the drain wire 63 and the shield 40. The shield 40 helps to reject external electromagnetic interference from the modular plug 12. The crimping loop 42 and drain wire 63 are also surrounded by the material of the module molding 50.

The wire 62D extends within the wire insert 100 in the view shown. The contact blade 70D of the modular plug 12 is pressed down and extends in part into the wire 62D. The contact blade 70D makes an electrical coupling to the wire 62D in the arrangement shown. The other contact blades of the modular plug 12 are also electrically coupled to the other wires 62 of the cable 60 in a similar way.

The interlock 28 of the modular plug housing 20 is also locked into position, providing a mechanical interference in the strain relief groove 110 of the wire insert 100. A portion of the wire 62D, for example, is exposed within the strain relief groove 110. The interlock 28 is pressed and locked into position into the area within the strain relief groove 110, as part of the crimping step described above. Particularly, the interlock edge 28A of the interlock 28 is snapped and seated below the locking edge 26A of the molding relief tab 26. The interlock 28 is thus held and locked in place based on a mechanical interference between the interlock edge 28A and the locking edge 26A.

The interlock 28 is compressed against the wire 62D, among others, which are exposed over the strain relief groove 110 of the wire insert 100, in this locked position. Particularly, the interlock corner 28B of the interlock 28 is pressed into or against the wire 62D. The interlock 28 thus provides a direct, on-wire strain relief, as it is pressed against the wires 62 of the cable 60 in this arrangement. Rather than the interlock 28 compressing against the outer jacket 61 of the cable 60, for example, the interlock 28 directly contacts the wires 62 or sleeves of the wires 62, holding the wires 62 and the wire insert 100 in place.

Because the wires 62 within the cable 60 are mechanically secured using the on-wire strain relief design within the modular plug 12, the cable assembly 10 can withstand significant, and opposite, pulling forces between the cable 60 and the modular plug 12, without separation, damage, or loss in signal coupling integrity. If the modular plug 12 were inserted and locked into a port or receptacle, for example, and the cable 60 was pulled out or away from the plug, 12, a mechanical interference between the interlock 28 and the wires 62 would prevent the wires 62 from being pulled out of the modular plug 12. The wire insert 100, also, cannot be removed from within the modular plug 12, due to a mechanical interference between the interlock surface 28C of the interlock 28 and the surface 110A (see FIG. 7A) of the relief groove 110.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

1. A cable assembly, comprising:
a cable, the cable comprising an outer jacket and a plurality of twisted pairs of wires extending within the outer jacket; and
a modular plug at one end of the cable, the modular plug comprising a modular housing and an interlock for on-wire strain relief between the twisted pairs of wires and the modular plug.

2. The cable assembly of claim 1, wherein:
the cable further comprises a drain wire extending within the outer jacket;
the modular plug further comprises a shield; and
the drain wire is crimped and electrically coupled to a crimping loop of the shield.

3. The cable assembly of claim 1, wherein:
the modular plug further comprises a wire insert;
the wire insert comprises a wire insert channel; and
the wire insert channel comprises a planar extension region and an incline extension region.

4. The cable assembly of claim 3, wherein:
the planar extension region of the wire insert extends parallel to a bottom surface of the wire insert; and
the incline extension region of the wire insert extends at an angle with respect to the bottom surface of the wire insert.

5. The cable assembly of claim 3, wherein the wire insert further comprises a strain relief groove that extends, from a top surface of the wire insert, into the wire insert.

6. The cable assembly of claim 3, wherein:
the wire insert further comprises a strain relief groove that extends, from a top surface of the wire insert, into the wire insert; and
the strain relief groove intersects with and opens the wire insert channel in the incline extension region.

7. The cable assembly of claim 3, wherein the interlock of the modular plug extends into a strain relief groove of the wire insert, locking the wire insert within the modular plug by a mechanical interference between the wire insert and the interlock.

8. The cable assembly of claim 3, wherein:
a wire of the cable extends through the wire insert channel of the wire insert;
a region of the wire is exposed over a strain relief groove of the wire insert; and
the interlock of the modular plug extends into the strain relief groove of the wire insert, securing the wire within the modular plug by a mechanical interference between the wire and the interlock.

9. The cable assembly of claim 1, further comprising a module molding formed between the cable and the modular plug, wherein the outer jacket is cut away and ends within the module molding, before the modular plug.
